(19) United States
(12) Patent Application Publication
(10) Pub. No.: US 2024/0402551 A1
(43) Pub. Date: Dec. 5, 2024

(54) ELECTRONIC DEVICE AND MANUFACTURING METHOD OF ELECTRONIC DEVICE

(71) Applicants: Innolux Corporation, Miaoli County (TW); CARUX TECHNOLOGY PTE. LTD., SINGAPORE (SG)

(72) Inventors: Li-Wei Sung, Tainan (TW); Cheng-Tso Chen, Miaoli County (TW); Yu-Ti Huang, Miaoli County (TW); Kuei-Chen Chiu, Miaoli County (TW); Pin-Lin Cheng, Miaoli County (TW)

(73) Assignees: Innolux Corporation, Miaoli County (TW); CARUX TECHNOLOGY PTE. LTD., SINGAPORE (SG)

(21) Appl. No.: 18/656,537

(22) Filed: May 6, 2024

(30) Foreign Application Priority Data
Jun. 2, 2023 (CN) 202310649663.5

(51) Int. Cl. G02F 1/1362; G02F 1/1343; G02F 1/1368

(52) U.S. Cl. CPC G02F 1/136227; G02F 1/134363; G02F 1/13439; G02F 1/13685

(57) ABSTRACT

An electronic device including a substrate and a plurality of control units is provided. The plurality of control units are disposed on the substrate, wherein each of the plurality of control units includes a transistor, an insulating layer, a first conductive layer, and a second conductive layer. The transistor includes a first electrode. The insulating layer is disposed on the transistor and has a through hole exposing the first electrode. The first conductive layer is disposed on the transistor, wherein a portion of the first conductive layer is overlapped with the insulating layer, and another portion of the first conductive layer is electrically connected to the first electrode via the through hole. The second conductive layer is at least partially overlapped with the first conductive layer and in direct contact with the first conductive layer. The electronic device provided by the disclosure has improved transmittance and yield.

### CROSS-REFERENCE TO RELATED APPLICATION

This application claims the priority benefit of China application serial no. 202310649663.5, filed on Jun. 2, 2023. The entirety of the above-mentioned patent application is hereby incorporated by reference herein and made a part of this specification.

### BACKGROUND

### Technical Field

The disclosure relates to an electronic device, in particular to an electronic device including a pixel electrode.

### Description of Related Art

A pixel electrode in an existing electronic device is electrically connected to an electrode of a transistor via a through hole penetrating an insulating layer. However, if the thickness of the pixel electrode is too small, the pixel electrode disposed in the through hole of the insulating layer is readily broken due to topographical factors, thus reducing the yield of the electronic device. Relatively, if the thickness of the pixel electrode is too large, the transmittance of the electronic device is decreased.

### SUMMARY

Some embodiments of the disclosure are directed to an electronic device having improved transmittance and yield.

According to some embodiments of the disclosure, an electronic device includes a substrate and a plurality of control units. The plurality of control units are disposed on the substrate, wherein each of the plurality of control units includes a transistor, an insulating layer, a first conductive layer, and a second conductive layer. The transistor includes a first electrode. The insulating layer is disposed on the transistor and has a through hole exposing the first electrode. The first conductive layer is disposed on the transistor, wherein a portion of the first conductive layer is overlapped with the insulating layer, and another portion of the first conductive layer is electrically connected to the first electrode via the through hole. The second conductive layer is at least partially overlapped with the first conductive layer and in direct contact with the first conductive layer.

In order to make the above features and advantages of the disclosure better understood, embodiments are specifically provided below with reference to figures for detailed description as follows.

### BRIEF DESCRIPTION OF THE DRAWINGS

FIG. 1 is a flowchart of a manufacturing method of an electronic device of an embodiment of the disclosure.

FIG. 2 is a schematic partial cross-sectional view of an electronic device of an embodiment of the disclosure.

FIG. 3A is a schematic partial top view of an electronic device of an embodiment of the disclosure.

FIG. 3B is a schematic partial top view of an opening region and a shielding region in an electronic device of an embodiment of the disclosure.

FIG. 4 is a schematic partial cross-sectional view of an electronic device of another embodiment of the disclosure.

### DESCRIPTION OF THE EMBODIMENTS

Hereinafter, reference will be made in detail to exemplary embodiments of the disclosure, and examples of the exemplary embodiments are illustrated in the figures. Wherever possible, the same reference numerals are used in the figures and the descriptions to refer to the same or similar portions.

The disclosure may be understood by referring to the following detailed description in conjunction with the accompanying figures. It should be noted that in order to facilitate understanding to the reader and to simplify the figures, the multiple figures in the disclosure depict a portion of the electronic device, and certain components in the figures are not drawn to actual scale. In addition, the quantity and dimension of each component in the figures are for illustration, and are not intended to limit the scope of the disclosure.

Certain terms are used throughout the specification and the appended claims of the disclosure to refer to particular components. Those skilled in the art should understand that electronic device manufacturers may refer to the same components under different names. This specification does not intend to distinguish between those components that have the same function but have different names. In the following description and claims, the words “including”, “containing”, “having” and the like are open words, so they should be interpreted as meaning “including but not limited to . . . ” Therefore, when the terms “including”, “containing”, and/or “having” are used in the description of the disclosure, they specify the presence of corresponding features, regions, steps, operations, and/or members, but do not exclude the presence of one or more corresponding features, regions, steps, operations, and/or members.

The terminology mentioned in the specification, such as: “up”, “down”, “front”, “rear”, “left”, “right”, etc., are directions referring to the figures. Therefore, the directional terms used are used for illustration, not for limiting the disclosure. In the figures, each figure depicts general features of methods, structures, and/or materials used in specific embodiments. However, these figures should not be construed to define or limit the scope or nature covered by these embodiments. For example, for clarity, the relative dimension, thickness, and location of each film, region, and/or structure may be reduced or enlarged.

When a corresponding member (e.g., a layer or a region) is referred to as being “on another member”, the corresponding member may be directly on the other member, or other members may be present in between. Moreover, when a member is referred to as being “directly on another member”, there is no intervening member unless otherwise specified in the specification. In addition, when a member is referred to as “on another member”, the two members have an up-down relationship in the top view, and this member may be above or below the other member, and this up-down relationship depends on the orientation of the device.

The terms “equal to” or “the same”, “substantially”, or “essentially” are generally interpreted as being within 20% of a given value, or interpreted as being within 10%, 5%, 3%, 2%, 1%, or 0.5% of a given value.

The ordinal numbers used in the specification and claims, such as “first”, “second”, etc., are used to modify a component. They do not themselves imply and represent that the component(s) have any previous ordinal quantity, and also do not represent the order of one component and another component, or the order of manufacturing methods. The use of these ordinal numbers is to clearly distinguish a component with a certain name from another component with the same name. The same terms may be not used in the claims and the specification, and accordingly, the first member in the specification may be the second member in the claims.

It should be noted that in the following embodiments, the features in several different embodiments may be replaced, recombined, and mixed to complete other embodiments without departing from the spirit of the disclosure. As long as the features between the embodiments do not violate the spirit of the disclosure or conflict with each other, they may be mixed and used arbitrarily.

The electrical connection described in the disclosure may refer to direct connection or indirect connection. In the case of direct connection, the endpoints of the components on two circuits are directly connected or connected to each other by a conductive line segment. In the case of indirect connection, there is a switch, diode, capacitor, inductor, other suitable members, or a combination of the components between the endpoints of the components on the two circuits, but the disclosure is not limited thereto.

In the disclosure, thickness, length, width, and area may be measured by an optical microscope, and the thickness may be measured by a cross-sectional image in an electron microscope, but the disclosure is not limited thereto. In addition, there may be a certain error in any two values or directions for comparison. If the first value is equal to the second value, it implies that there may be an error of about 10% between the first value and the second value; if the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees.

An electronic device of the disclosure may be a non-self-luminous display equipment or a self-luminous display equipment, and may be a double-sided display equipment. The display equipment may include, for example, diode, liquid crystal, light-emitting diode (LED), quantum dot (QD), fluorescence, phosphor, other suitable display media, or a combination of the above. The LED may include, for example, organic light-emitting diode (OLED), mini LED, micro-LED, or QDLED, but the disclosure is not limited thereto. It should be noted that the display equipment may be any combination of the above, but the disclosure is not limited thereto. In addition, the shape of the display equipment may be rectangular, circular, polygonal, with curved edges, or other suitable shapes. The display equipment may have a peripheral system such as a drive system, a control system, and a light source system.

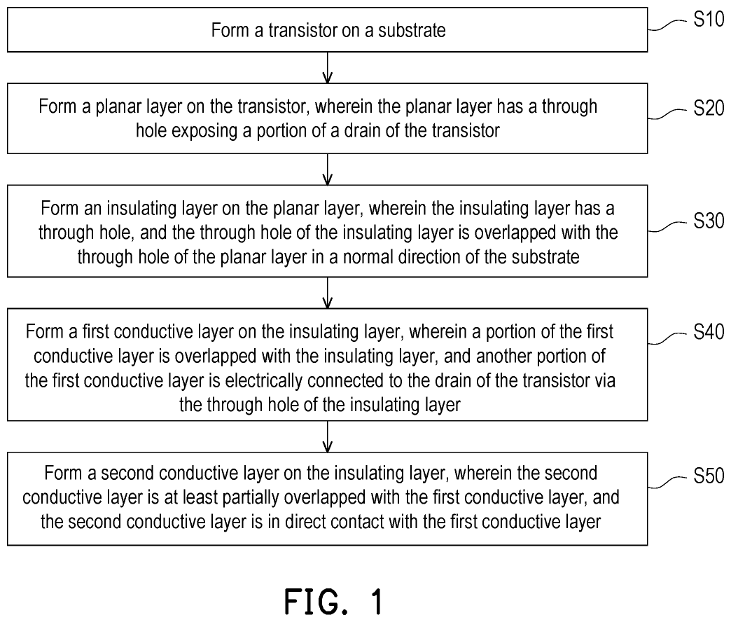

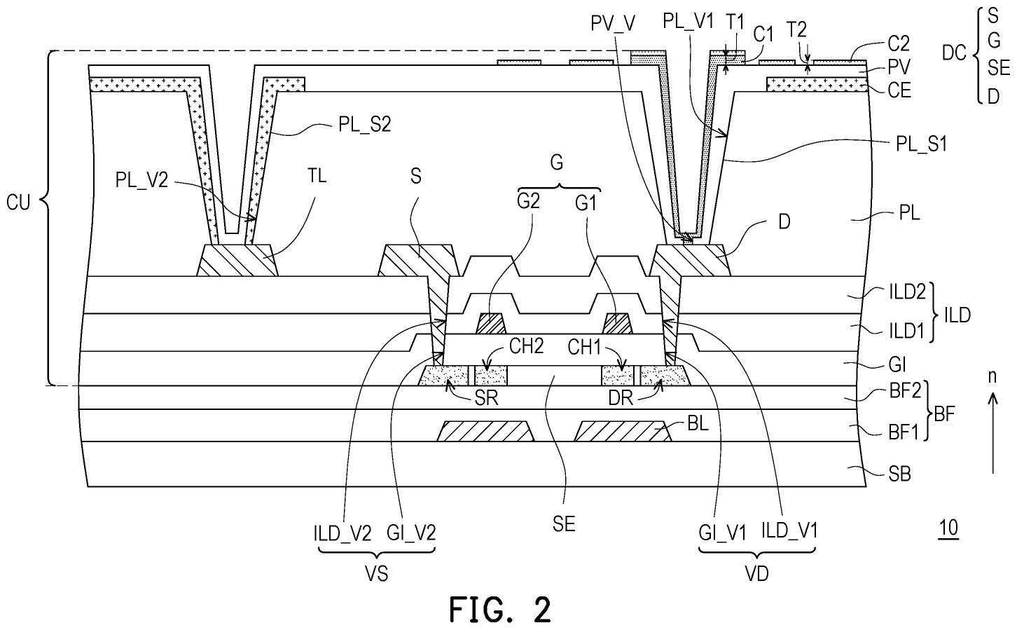

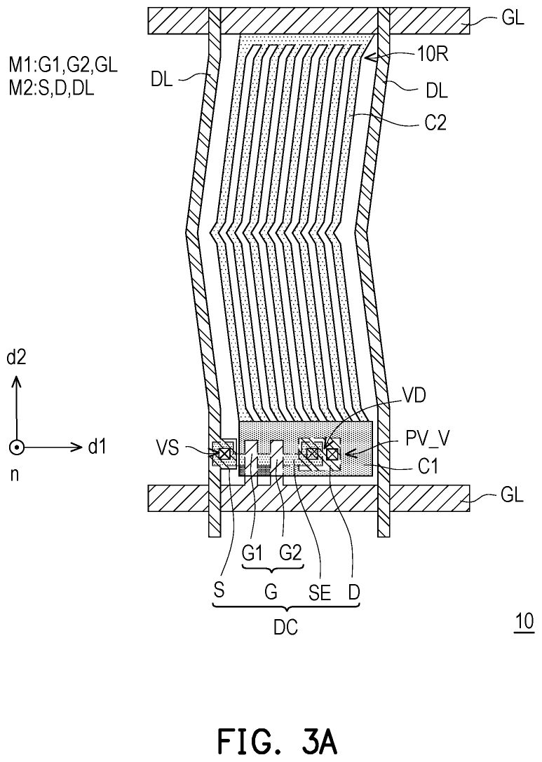

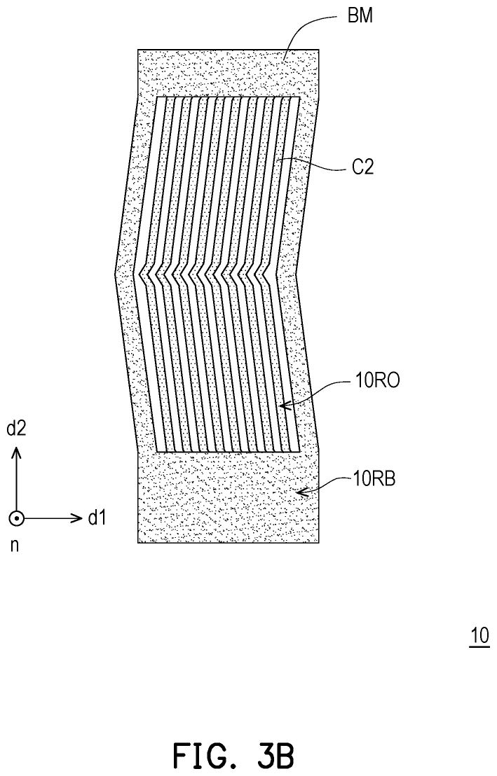

FIG. 1 is a flowchart of a manufacturing method of an electronic device of an embodiment of the disclosure, FIG. 2 is a partial cross-sectional schematic diagram of an electronic device of an embodiment of the disclosure, and FIG. 3A is a schematic partial top view of an electronic device of an embodiment of the disclosure.

The following will introduce the manufacturing method of an electronic device 10 of the present embodiment, but it should be noted that the manufacturing method of the electronic device of the disclosure is not limited thereto.

Please refer to FIG. 1, FIG. 2, and FIG. 3A at the same time. In step S10, a transistor DC is formed on a substrate SB.

The substrate SB may, for example, include a flexible substrate or an inflexible substrate, wherein the material of the substrate SB may, for example, include glass, plastic, or a combination thereof. For example, the substrate SB may include quartz, sapphire, polymethyl methacrylate (PMMA), polycarbonate (PC), polyimide (PI), polyethylene terephthalate (PET), or other suitable materials, or a combination of the above materials. In the present embodiment, the material of the substrate SB is glass, but the disclosure is not limited thereto.

In some embodiments, the transistor DC may be formed on the substrate SB by performing the following steps, but the disclosure is not limited thereto.

Step (1): a light-shielding layer BL is formed on the substrate SB. The forming method of the light-shielding layer BL may be, for example, first forming a light-shielding material layer (not shown) on the substrate SB by physical vapor deposition or other suitable processes, and then performing a patterning process on the light-shielding material layer, but the disclosure is not limited thereto. The light-shielding layer BL may be, for example, at least partially overlapped with a channel region CH of a semiconductor layer SE of the transistor DC to be introduced later in a normal direction n of the substrate SB. In this way, the deterioration of the channel region CH of the semiconductor layer SE due to the irradiation of external ambient light may be reduced. In some embodiments, the material of the light-shielding layer BL may include a material having a transmittance lower than 30%, but the disclosure is not limited thereto.

Step (2): a buffer layer BF is formed on the substrate SB, wherein the buffer layer BF may cover the light-shielding layer BL. The forming method of the buffer layer BF may be forming on the substrate SB by, for example, chemical vapor deposition or other suitable processes, but the disclosure is not limited thereto. The buffer layer BF may, for example, have a relatively good combination with a layer subsequently formed thereon, but the disclosure is not limited thereto. The material of the buffer layer BF may be, for example, an inorganic material (e.g., silicon oxide, silicon nitride, silicon oxynitride, or a stacked layer of at least two of the above materials), and the buffer layer BF may be, for example, a single-layer structure or a multi-layer structure. In the present embodiment, the buffer layer BF includes a multi-layer structure sequentially stacked by a buffer sublayer BF1 and a buffer sublayer BF2, wherein the material of the buffer sublayer BF1 includes silicon nitride, and the material of the buffer sublayer BF2 includes silicon oxide, but the disclosure is not limited thereto. In some embodiments, the materials of the buffer sublayer BF1 and the buffer sublayer BF2 may be interchanged.

Step (3): the semiconductor layer SE is formed on the buffer layer BF. The forming method of the semiconductor layer SE may be, for example, first forming a semiconductor material layer (not shown) on the buffer layer BF by chemical vapor deposition or other suitable processes, and then performing a patterning process on the semiconductor material layer, but the disclosure is not limited thereto. In some embodiments, the semiconductor layer SE has the channel region CH and a source region SR and a drain region DR located at opposite sides of the channel region CH, wherein the channel region CH is at least partially overlapped with a gate G to be mentioned later in the normal direction n of the substrate SB, and the source region SR and the drain region DR may be electrically connected to a source S and a drain D mentioned later respectively. In the present embodiment, the transistor DC is a double-gate thin-film transistor. Therefore, the channel region CH may include a channel region CH1 and a channel region CH2, each of which is overlapped with a gate G1 and a gate G2 in the gate G described later in the normal direction n of the substrate SB, but the disclosure is not limited thereto.

The material of the semiconductor layer SE may include, for example, low-temperature polysilicon (LTPS), metal oxide, amorphous silicon (a-Si), or a combination thereof, but the disclosure is not limited thereto. For example, the material of the semiconductor layer SE may include, but not limited to, amorphous silicon, polysilicon, germanium, compound semiconductor (such as gallium nitride, silicon carbide, gallium arsenide, gallium phosphide, indium phosphide, indium arsenide, and/or indium antimonide), alloy semiconductor (e.g., SiGe alloy, GaAsP alloy, AlInAs alloy, AlGaAs alloy, GaInAs alloy, GaInP alloy, GaInAsP alloy), metal oxide (such as indium gallium zinc oxide (IGZO), indium zinc oxide (IZO), indium gallium zinc oxide (IGZTO)), or an organic semiconductor including a polycyclic aromatic compound, or a combination of the above. In the present embodiment, the material of the semiconductor layer SE is low-temperature polysilicon, but the disclosure is not limited thereto.

Step (4): a gate insulating layer GI, a first metal layer M1, and an insulating layer ILD are formed on the buffer layer BF, wherein the gate insulating layer GI is disposed on the buffer layer BF, for example, the first metal layer M1 includes the gate G and is disposed on the gate insulating layer GI, for example, and the insulating layer ILD is disposed on the gate insulating layer GI and covers the gate G, for example.

In some embodiments, the gate insulating layer GI has a through hole GI_V1 and a through hole GI_V2, the insulating layer ILD has a through hole ILD_V1 and a through hole ILD_V2, the through hole GI_V1 may communicate with the through hole ILD_V1 to form a through hole VD and together expose the drain region DR of the semiconductor layer SE, and the through hole GI_V2 communicates with the through hole ILD_V2 to form a through hole VS and together expose the source region SR of the semiconductor layer SE.

The forming method of the gate insulating layer GI may be, for example, first forming a gate insulating material layer (not shown) on the buffer layer BF by chemical vapor deposition or other suitable processes, and then performing a patterning process on the gate insulating material layer to form the through hole GI_V1 and the through hole GI_V2, but the disclosure is not limited thereto. The material of the gate insulating layer GI may be, for example, an inorganic material (e.g., silicon oxide, silicon nitride, silicon oxynitride, or a stacked layer of at least two of the above materials). In the present embodiment, the gate insulating layer GI is a single-layer structure including silicon oxide, but the disclosure is not limited thereto. It should be mentioned that, the channel region CH of the semiconductor layer SE may be formed by doping the semiconductor material layer with ions of elements such as phosphorus (P) and boron (B) after the gate insulating layer GI is formed, and the ion concentration may be different at each position of the semiconductor layer SE. However, the disclosure is not limited thereto.

The forming method of the first metal layer M1 may be, for example, first forming a first metal material layer (not shown) on the gate insulating layer GI by physical vapor deposition, metal chemical vapor deposition, or other suitable processes, and then performing a patterning process on the first metal material layer, but the disclosure is not limited thereto. In the present embodiment, the transistor DC is a double-gate TFT. Therefore, the first metal layer M1 includes the gate G1 and the gate G2 separated from each other, but the disclosure is not limited thereto. In the present embodiment, as shown in FIG. 3A, the first metal layer M1 further includes a gate line GL, wherein the gate line GL is extended toward a first direction d1 and electrically connected to the gate G1 and the gate G2 to transmit a signal from, for example, a gate driver (not shown) to the transistor DC, but the disclosure is not limited thereto. The first direction d1 is, for example, perpendicular to the normal direction n of the substrate SB, but the disclosure is not limited thereto. The material of the first metal layer M1 may include, for example, a suitable conductive material, but the disclosure is not limited thereto. It should be mentioned that, the source region SR and the drain region DR of the semiconductor layer SE may be formed by using the first metal layer M1 as a mask to dope the semiconductor material layer after the first metal layer M1 is formed, but the disclosure is not limited thereto.

The forming method of the insulating layer ILD may be, for example, first forming an insulating material layer (not shown) on the gate insulating layer GI by using a chemical vapor deposition method or other suitable processes, then performing a patterning process on the insulating material layer to form the through hole ILD_V1 and through hole ILD_V2, wherein the through hole ILD_V1 and the through hole ILD_V2 may be formed in the same patterning process as the through hole GI_V1 and the through hole GI_V2 respectively, but the disclosure is not limited thereto. The material of the insulating layer ILD may be, for example, an inorganic material (e.g., silicon oxide, silicon nitride, silicon oxynitride, or a stacked layer of at least two of the above materials), and the insulating layer ILD may be a single-layer structure or a multi-layer structure. In the present embodiment, the insulating layer ILD includes a multilayer structure in which an insulating sublayer ILD1 and an insulating sublayer ILD2 are stacked in sequence, wherein both the material of the insulating sublayer ILD1 and the material of the insulating sublayer ILD2 include silicon nitride, but the disclosure is not limited thereto. In some embodiments, the material of the insulating layer ILD may also be an organic material.

Step (5): a second metal layer M2 is formed on the insulating layer ILD. The forming method of the second metal layer M2 may be, for example, first forming a second metal material layer (not shown) on the insulating layer ILD by physical vapor deposition, metal chemical vapor deposition, or other suitable processes, and then performing a patterning process on the second metal material layer, but the disclosure is not limited thereto. In the present embodiment, the second metal layer M2 includes the source S, the drain D, a data line DL, and/or a touch signal line TL, but the disclosure is not limited thereto. The source S and the drain D are, for example, separated from each other, wherein the source S may be electrically connected to the source region SR of the semiconductor layer SE, for example, via the through hole VS, and the drain D may be electrically connected to the drain region DR of the semiconductor layer SE, for example, via the through hole VD. As shown in FIG. 3A, the data line DL is extended toward a second direction d2, for example, and electrically connected to the source S, for example, to transfer a signal from a source driver (not shown) to the transistor DC, but the disclosure is not limited thereto. The touch signal line TL is also extended, for example, toward the second direction d2, and is, for example, electrically connected to a common electrode CE to be introduced later, so as to transmit the signal from the common electrode CE to an external signal processing circuit (not shown), but the disclosure is not limited thereto. The second direction d2 is, for example, perpendicular to the first direction d1 and the normal direction n of the substrate SB, but the disclosure is not limited thereto. The material of the second metal layer M2 may include, for example, a suitable conductive material, but the disclosure is not limited thereto.

So far, the manufacture of the transistor DC of the present embodiment is completed, but the disclosure is not limited thereto. In detail, the semiconductor layer SE, the gate G, the source S, and the drain D may form the transistor DC. It should be noted that although the present embodiment shows that the transistor DC is any top-gate thin-film transistor known to those skilled in the art, the disclosure is not limited thereto.

Please continue to refer to FIG. 1, FIG. 2, and FIG. 3A, in step S20, a planar layer PL is formed on the transistor DC, wherein the planar layer PL has a through hole PL_V1 exposing a portion of the drain D of the transistor DC. In some embodiments, the planar layer PL further has a through hole PL_V2, wherein the through hole PL_V2 exposes a portion of the touch signal line TL. From another point of view, the planar layer PL, for example, has a sidewall PL_S1 and a sidewall PL_S2, wherein the sidewall PL_S1 and the sidewall PL_S2 may respectively define the contours of the through hole PL_V1 and the through hole PL_V2, for example.

The forming method of the planar layer PL may be, for example, first forming an embedded planar material layer (not shown) on the insulating layer ILD by chemical vapor deposition or other suitable processes, and then performing a patterning process on the planar oxide material layer to form the through hole PL_V1 and the through hole PL_V2, but the disclosure is not limited thereto. The material of the planar layer PL may be, for example, an organic material (for example: polyimide resin (PI), epoxy resin, or acrylic resin), but the disclosure is not limited thereto.

In some embodiments, after the planar layer PL is formed on the transistor DC, the common electrode CE may be formed on the planar layer PL. The forming method of the common electrode CE may be, for example, first forming a common electrode material layer (not shown) on the planar layer PL by physical vapor deposition or other suitable processes, and then performing a patterning process on the common electrode material layer, but the disclosure is not limited thereto. In the present embodiment, the common electrode CE is partially filled in the through hole PL_V2 of the planar layer PL to be electrically connected to the touch signal line TL, but the disclosure is not limited thereto. The material of the common electrode CE may include transparent conductive oxide, for example. For example, the material of the common electrode CE may include, indium tin oxide (ITO), antimony zinc oxide (AZO), tin oxide (SnO), zinc oxide (ZnO), indium zinc oxide (IZO), antimony tin oxide (ATO), fluorine-doped tin oxide (FTO), other suitable transparent conductive materials, or any combination of the above, but the disclosure is not limited thereto.

Please continue to refer to FIG. 1, FIG. 2, and FIG. 3A, in step S30, an insulating layer PV is formed on the planar layer PL, wherein the insulating layer PV has a through hole PV_V, and the through hole PV_V of the insulating layer PV is overlapped with the through hole PL_V1 of the planar layer PL in the normal direction n of the substrate SB. Specifically, the insulating layer PV may be, for example, partially filled in the through hole PL_V1 of the planar layer PL and disposed on the sidewall PL_S1 of the planar layer PL, and can, for example, partially cover the drain D exposed by the through hole PL_V1 of the planar layer PL, so that the through hole PV_V of the insulating layer PV and the through hole PL_V1 of the planar layer PL may together expose a portion of the drain D.

In some embodiments, the insulating layer PV may also be filled in the through hole PL_V2 of the planar layer PL and disposed on the sidewall PL_S2 of the planar layer PL, and may cover the common electrode CE filled in the through hole PL_V2 of the planar layer PL.

The forming method of the insulating layer PV may be, for example, first forming an insulating material layer (not shown) on the planar layer PL by chemical vapor deposition or other suitable processes, and then performing a patterning process on the insulating material layer to form the through hole PV_V, but the disclosure is not limited thereto. The material of the insulating layer PV may be, for example, an inorganic material (e.g., silicon oxide, silicon nitride, silicon oxynitride, or a stacked layer of at least two of the above materials), but the disclosure is not limited thereto.

Please continue to refer to FIG. 1, FIG. 2, and FIG. 3A, in step S40, a first conductive layer C1 is formed on the insulating layer PV, wherein a portion of the first conductive layer C1 is overlapped with the insulating layer PV, and another portion of the first conductive layer C1 is electrically connected to the drain D of the transistor DC via the through hole PV_V of the insulating layer PV. In detail, in the present embodiment, the first conductive layer C1 is partially filled in the through hole PL_V1 of the planar layer PL and the through hole PV_V of the insulating layer PV, a portion of the first conductive layer C1 may be disposed on the sidewall PL_S1 of the planar layer PL in sequence with the insulating layer PV and overlapped with the insulating layer PV, for example, and another portion of the first conductive layer C1 may be electrically connected to the drain D via the through hole PV_V of the insulating layer PV, for example. In the present embodiment, a thickness T1 of the first conductive layer C1 may be between 50 nm and 70 nm (50 nm≤T1≤70 nm). When the thickness T1 of the first conductive layer C1 is within the above range, the possibility of cracking of the first conductive layer C1 disposed on the sidewall PL_S1 of the planar layer PL may be reduced, so as to improve the yield of the electronic device 10. The material of the first conductive layer C1 may, for example, include metal, metal nitride, semiconductor material, transparent conductive oxide, any other suitable conductive material, or a combination thereof. For example, the material of the first conductive layer C1 may include gold (Au), nickel (Ni), platinum (Pt), palladium (Pd), iridium (Ir), titanium (Ti), chromium (Cr), tungsten (W), aluminum (Al), copper (Cu), molybdenum (Mo), titanium (Ti), silver (Ag), magnesium (Mg), an alloy thereof or a compound thereof, indium tin oxide (ITO), antimony zinc oxide (AZO), tin oxide (SnO), zinc oxide (ZnO), indium zinc oxide (IZO), antimony tin oxide (ATO), fluorine-doped tin oxide (FTO), other suitable conductive materials, or any combination of the above, but the disclosure is not limited thereto.

The forming method of the first conductive layer C1 may be, for example, first forming a first conductive material layer (not shown) on the insulating layer PV by physical vapor deposition or other suitable processes, and then performing a patterning process on the first conductive material layer, but the disclosure is not limited thereto.

Please continue to refer to FIG. 1, FIG. 2, and FIG. 3A, in step S50, a second conductive layer C2 is formed on the insulating layer PV, wherein the second conductive layer C2 and the first conductive layer C1 are at least partially overlapped, and the second conductive layer C2 is in direct contact with the first conductive layer C1. The second conductive layer C2 of the present embodiment is used, for example, as a pixel electrode of the electronic device 10, but the disclosure is not limited thereto. In the present embodiment, the second conductive layer C2 is at least partially overlapped with the first conductive layer C1 not disposed in the through hole PL_V1 of the planar layer PL and in direct contact with the first conductive layer C1 not disposed in the through hole PL_V1 of the planar layer PL. Accordingly, the second conductive layer C2 may be electrically connected to the drain D via the first conductive layer C1, so that a thickness T2 of the second conductive layer C2 may be reduced accordingly. In the present embodiment, the thickness T2 of the second conductive layer C2 is between 5 nm and 50 nm (5 nm≤T2≤50 nm). When the thickness T2 of the second conductive layer C2 is within the above range, the transmittance of the electronic device 10 may be increased to improve the brightness of the electronic device 10. The material of the second conductive layer C2 may include transparent conductive oxide, for example. For example, the material of the second conductive layer C2 may include, indium tin oxide (ITO), antimony zinc oxide (AZO), tin oxide (SnO), zinc oxide (ZnO), indium zinc oxide (IZO), antimony tin oxide (ATO), fluorine-doped tin oxide (FTO), other suitable transparent conductive materials, or any combination of the above, but the disclosure is not limited thereto.

The forming method of the second conductive layer C2 may be, for example, first forming a second conductive material layer (not shown) on the insulating layer PV by physical vapor deposition or other suitable processes, and then performing a patterning process on the second conductive material layer, but the disclosure is not limited thereto. It should be noted that, as shown in FIG. 2, due to the lamination relationship of the insulating layer PV, the first conductive layer C1, and the second conductive layer C2, at a place adjacent to the opening of the through hole PL_V1, the top surface of the second conductive layer C2 is higher than the top surface of the first conductive layer C1, and the top surface of the first conductive layer C1 is higher than the top surface of the insulating layer PV. However, due to the thickness difference between the first conductive layer C1 and the second conductive layer C2, at a place farther from the opening of the through hole PL_V1, the top surface of the second conductive layer C2 is lower than the top surface of the first conductive layer C1 adjacent to the opening of the through hole PL_V1.

So far, the manufacture of the electronic device 10 of the present embodiment is completed, but the method of manufacturing the electronic device 10 of the disclosure is not limited thereto.

The following will briefly introduce the structure of the electronic device 10 of the present embodiment with reference to FIG. 2 and FIG. 3A and FIG. 3B, wherein FIG. 3B is a schematic top view of an opening region and a shielding region in an electronic device of an embodiment of the disclosure, but the disclosure is not limited thereto.

In the present embodiment, the electronic device 10 includes the substrate SB and a plurality of control units CU. The plurality of control units CU are, for example, disposed on the substrate SB, wherein each of the plurality of control units CU includes, for example, the transistor DC, the insulating layer PV, the first conductive layer C1, and the second conductive layer C2. The transistor DC includes, for example, the gate G, a first electrode (the drain D), and a second electrode (the source S). The insulating layer PV is, for example, disposed on the transistor DC and has the through hole PV_V exposing the first electrode (the drain D). The first conductive layer C1 is, for example, disposed on the transistor DC, wherein a portion of the first conductive layer C1 is overlapped with the insulating layer PV, and another portion of the first conductive layer C1 is electrically connected to the first electrode (the drain D) via the through hole PV_V. The second conductive layer C2 is, for example, at least partially overlapped with the first conductive layer C1 and in direct contact with the first conductive layer C1.

In the present embodiment, the electronic device 10 includes a plurality of regions 10R defined by a plurality of first wires (e.g., gate lines GL) and a plurality of second wires (e.g., data lines DL). Specifically, the electronic device 10 may further include, for example, a plurality of first wires (such as the gate lines GL) and a plurality of second wires (such as the data lines DL) disposed on the substrate, wherein the first wires may be extended, for example, along the first direction d1, the second wires may be extended, for example, along the second direction d2, and the first direction d1 is different from the second direction d2.

As shown in FIG. 3A and FIG. 3B, one of the plurality of control units CU of the electronic device 10 of the present embodiment may be located, for example, within the region 10R surrounded by two adjacent first wires (e.g., the gate lines GL) and two adjacent second wires (e.g., the data lines DL). The region 10R of the electronic device 10 may include, for example, an opening region 10RO and a shielding region 10RB. That is, the opening region 10RO and the shielding region 10RB are located in the region 10R surrounded by two adjacent first wires (such as the gate lines GL) and two adjacent second wires (such as the data lines DL). In detail, the electronic device 10 may also include, for example, a shielding layer BM, wherein the shielding layer BM is overlapped with the components in the first conductive layer C1, the first wires (such as the gate lines GL), the second wires (such as the data lines DL), and the transistor DC in the normal direction n of the substrate SB, for example. The material of the light-shielding pattern BM may be, for example, black resin or metal material having lower reflectivity, so as to shield the wires and the components inside the electronic device 10 that are not intended to be seen by the user, so as to improve the display effect of the electronic device 10. That is, in the disclosure, the overlap portion with the shielding layer BM in the normal direction n of the substrate SB may be defined as the shielding region 10RB, and the non-overlap portion may be defined as the opening region 10RO.

In the present embodiment, in a top view (FIG. 3B), the plurality of opening regions 10RO defined by the shielding layer BM respectively expose a portion of the second conductive layer C2. In detail, as shown in FIG. 3A and FIG. 3B, a portion of the second conductive layer C2 may be not overlapped with the shielding layer BM in the normal direction n of the substrate SB. Since the material of the second conductive layer C2 includes transparent conductive oxide, the possibility of affecting the transmittance of the opening region 10RO may be reduced. Furthermore, the thickness T2 of the second conductive layer C2 in the electronic device 10 of the present embodiment is between 5 nm and 50 nm, thus increasing the transmittance of the opening region 10RO to improve the brightness of the electronic device 10.

In the present embodiment, in a top view (FIG. 3B), the first conductive layer C1 is located outside each of the plurality of opening regions 10RO. In detail, as shown in FIG. 3A and FIG. 3B, the first conductive layer C1 is overlapped with the shielding layer BM in the normal direction n of the substrate SB. That is, the first conductive layer C1 is located in the shielding region 10RB. Accordingly, in the present embodiment, in a top view (FIG. 3A), the area of the second conductive layer C2 may be greater than the area of the first conductive layer C1.

In addition, the first conductive layer C1 may be shielded by the shielding layer BM to reduce the possibility of affecting the transmittance of the opening region 10RO, so that the material selection of the first conductive layer C1 may have greater flexibility. In detail, in some embodiments, the material of the first conductive layer C1 is the same as the material of the second conductive layer C2 to simplify the process of the electronic device 10. In other embodiments, according to the design of the electronic device 10, the material of the first conductive layer C1 and the material of the second conductive layer C2 may be different. Moreover, by shielding the first conductive layer C1 by the shielding layer BM, the thickness T1 of the first conductive layer C1 may be designed to have a greater thickness, in order to increase the stability of the first conductive layer C1 filled in the through hole PL_V1 of the planar layer PL and at the same time reduce the influence of the thicker first conductive layer C1 on transmittance. In the present embodiment, the thickness T1 of the first conductive layer C1 is greater than the thickness T2 of the second conductive layer C2, wherein the thickness T1 of the first conductive layer C1 is between 50 nm and 70 nm. By making the thickness T1 of the first conductive layer C1 fall within the above range, the possibility of cracking of the first conductive layer C1 disposed on the sidewall PL_S1 of the planar layer PL may be reduced, so as to improve the yield of the electronic device 10.

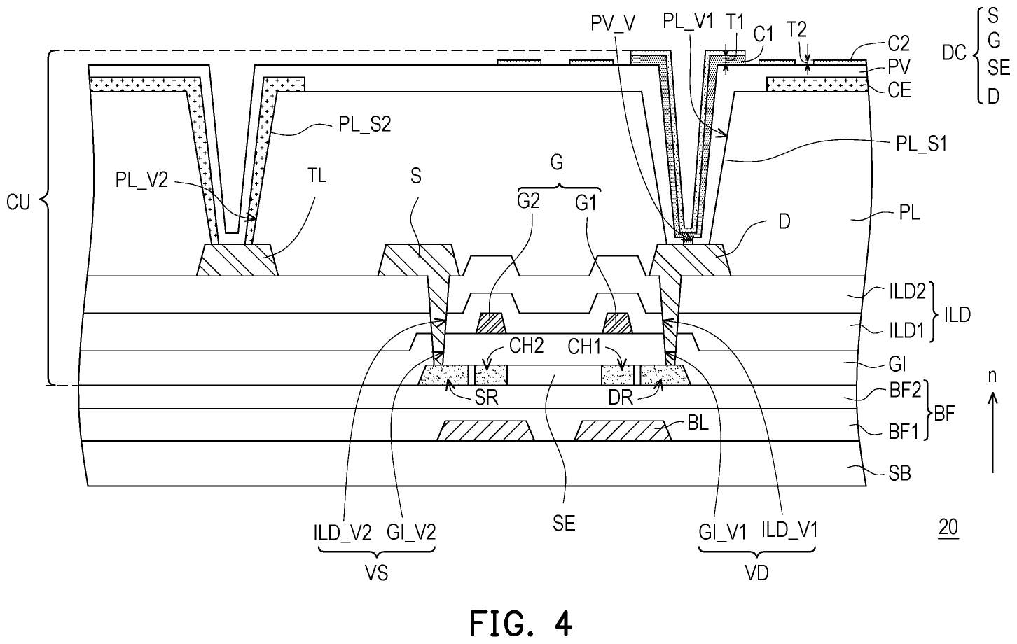

FIG. 4 is a schematic partial cross-sectional view of an electronic device of another embodiment of the disclosure. It must be noted here that the embodiment of FIG. 4 may adopt the reference numerals and a portion of the content of the embodiment of FIG. 2, wherein the same or similar reference numerals are used to represent the same or similar components, and the description of the same technical content is omitted.

The difference between an electronic device 20 of FIG. 4 and the electronic device 10 is that the second conductive layer C2 is further disposed in the through hole PL_V1 of the planar layer PL. That is, in the present embodiment, the second conductive layer C2 may further be at least partially overlapped with the first conductive layer C1 disposed in the through hole PL_V1 of the planar layer PL, and may further be in direct contact with the first conductive layer C1 disposed in the through hole PL_V1 of the planar layer PL.

Based on the above, in the electronic device provided by some embodiments of the disclosure, by disposing the first conductive layer having a relatively large thickness in the through hole of the insulating layer, the possibility of breakage of the first conductive layer and/or the second conductive layer disposed in the through hole of the insulating layer may be reduced, so as to improve the yield of the electronic device of some embodiments of the disclosure. Moreover, in some embodiments of the disclosure, the second conductive layer and the first conductive layer of the electronic device are electrically connected via direct contact, and by disposing the second conductive layer having a relatively small thickness and disposing the first conductive layer outside the opening region, the transmittance of the opening region in the electronic device of some embodiments of the disclosure may be increased, so as to improve the brightness of the electronic device of some embodiments of the disclosure.

Lastly, it should be noted that the above embodiments are used to describe the technical solution of the disclosure instead of limiting it. Although the disclosure has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the disclosure.

What is claimed is:

1. An electronic device, comprising:
a substrate; and
a plurality of control units disposed on the substrate, wherein one of the plurality of control units comprises:
a transistor comprising a first electrode;
an insulating layer disposed on the transistor and having a through hole exposing the first electrode;
a first conductive layer disposed on the transistor, wherein a portion of the first conductive layer is overlapped with the insulating layer, and another portion of the first conductive layer is electrically connected to the first electrode via the through hole; and
a second conductive layer at least partially overlapped with the first conductive layer and in direct contact with the first conductive layer, wherein in a top view, an area of the second conductive layer is greater than an area of the first conductive layer.

2. The electronic device of claim 1, wherein a thickness of the first conductive layer is less than a thickness of the second conductive layer.

3. The electronic device of claim 1, wherein a thickness of the first conductive layer is between 50 nm to 70 nm.

4. The electronic device of claim 1, wherein a thickness of the second conductive layer is between 5 nm to 50 nm.

5. The electronic device of claim 1, wherein the second conductive layer comprises a transparent conductive material.

6. The electronic device of claim 1, wherein a material of the first conductive layer is different from a material of the second conductive layer.

7. The electronic device of claim 1, wherein a material of the first conductive layer comprises gold (Au), nickel (Ni), platinum (Pt), palladium (Pd), iridium (Ir), titanium (Ti), chromium (Cr), tungsten (W), aluminum (Al), copper (Cu), molybdenum (Mo), titanium (Ti), silver (Ag), magnesium (Mg), an alloy thereof or a compound thereof, indium tin oxide (ITO), antimony zinc oxide (AZO), tin oxide (SnO), zinc oxide (ZnO), indium zinc oxide (IZO), antimony tin oxide (ATO), fluorine-doped tin oxide (FTO), or a combination thereof.

8. The electronic device of claim 1, wherein a material of the second conductive layer comprises indium tin oxide (ITO), antimony zinc oxide (AZO), tin oxide (SnO), zinc oxide (ZnO), indium zinc oxide (IZO), antimony tin oxide (ATO), fluorine-doped tin oxide (FTO), or a combination thereof.

9. The electronic device of claim 1, wherein a portion of the second conductive layer is disposed in the through hole of the insulating layer.

10. The electronic device of claim 1, wherein adjacent to the through hole, a top surface of the second conductive layer is higher than a top surface of the first conductive layer, and the top surface of the first conductive layer is higher than a top surface of the insulating layer.

11. The electronic device of claim 1, further comprising:
a plurality of first wires and a plurality of second wires are disposed on the substrate, the plurality of first wires are respectively extended along a first direction, and the plurality of second wires are respectively extended along a second direction, wherein the first direction is different from the second direction, and the one of the plurality of control units is located in a region surrounded by two adjacent first wires and two adjacent second wires.

12. The electronic device of claim 11, further comprising a plurality of opening regions, and in the top view, one of the plurality of opening regions is located in the region surrounded by the two adjacent first wires and the two adjacent second wires.

13. The electronic device of claim 12, wherein in the top view, each of the plurality of opening regions exposes a portion of the second conductive layer.

14. The electronic device of claim 12, wherein the first conductive layer is located outside each of the plurality of opening regions.

15. A manufacturing method of an electronic device, comprising:
forming a transistor on a substrate;
forming a planar layer on the transistor, wherein the planar layer has a first through hole exposing a portion of the transistor;
forming an insulating layer on the planar layer, wherein the insulating layer has a second through hole, and the second through hole of the insulating layer is overlapped with the first through hole of the planar layer in a normal direction of the substrate;
forming a first conductive layer on the insulating layer, wherein a portion of the first conductive layer is overlapped with the insulating layer, and another portion of the first conductive layer is electrically connected to the transistor via the second through hole of the insulating layer; and
forming a second conductive layer on the insulating layer, wherein the second conductive layer is at least partially overlapped with the first conductive layer, and the second conductive layer is in direct contact with the first conductive layer.

16. The electronic device of claim 15, wherein in the step of forming the second conductive layer on the insulating layer, a portion of the second conductive layer is formed in the second through hole of the insulating layer.

17. The manufacturing method of the electronic device of claim 15, further comprising:
forming a plurality of first wires on the substrate; and
forming a plurality of second wires on the substrate,
wherein the plurality of first wires are respectively extended along a first direction, the plurality of second wires are respectively extended along a second direction, the first direction is different from the second direction, and the transistor is located in a region surrounded by two adjacent first wires and two adjacent second wires.

18. The manufacturing method of the electronic device of claim 15, wherein the step of forming the transistor on the substrate comprises:
forming a semiconductor layer on the substrate;
forming a gate insulating layer, a first metal layer, and an interlayer insulating layer on the substrate; and
forming a second metal layer on the interlayer insulating layer.

19. The manufacturing method of the electronic device of claim 18, wherein the first metal layer comprises a gate, and the second metal layer comprises a source and a drain.

20. The manufacturing method of the electronic device of claim 15, further comprising:
forming a light-shielding layer on the substrate; and
forming a buffer layer on the substrate, wherein the buffer layer covers the light-shielding layer.
